(19) United States
(12) Patent Application Publication
(10) Pub. No.: US 2012/0233545 A1
(43) Pub. Date: Sep. 13, 2012

(54) DETECTION OF A HELD TOUCH ON A TOUCH-SENSITIVE DISPLAY

(76) Inventors: Akihiko Ikeda, Taipei (TW); James M. Mann, Cypress, TX (US)

(21) Appl. No.: 13/046,161

(22) Filed: Mar. 11, 2011

(51) Int. Cl. G06F 3/041; G06F 3/048

(52) U.S. Cl. 715/702; 345/173

(57) ABSTRACT

Example embodiments relate to detection of a held touch on a touch-sensitive display. In some embodiments, a touch held at a given position of a touch-sensitive display is detected. Movement of the touch is then tracked while the touch remains held on the touch-sensitive display. Finally, upon release of the held touch, an action is performed on a user interface object located at a position of the release of the held touch.

### BACKGROUND

As computing devices have developed, a significant amount of research and development has focused on improving the interaction between users and devices. One prominent result of this research is the advent of touch-enabled devices, which allow a user to directly provide input by interacting with a touch-sensitive display using a finger or stylus, By eliminating or minimizing the need for keyboards, mice, and other traditional input devices, touch-based input allows a user to control a device in a more natural, intuitive manner.

### BRIEF DESCRIPTION OF THE DRAWINGS

The following detailed description references the drawings, wherein:

FIG. 1 is a block diagram of an example computing device for detection of a held touch on a touch-sensitive display;

FIG. 2 is a block diagram of an example computing device including an operating system and an application that interact to detect and respond to a held touch on a touch-sensitive display;

FIG. 3 is a flowchart of an example method for detection of a held touch on a touch-sensitive display;

FIG. 4 is a flowchart of an example method for detection of a held touch, the method changing the appearance of user interface objects and scrolling a viewable area of a current window;

FIG. 5A is a diagram of an example user interface in which a user has initiated a held touch;

FIG. 5B is a diagram of an example user interface including an indication displayed after a user has held a touch for a given duration of time;

FIG. 5C is a diagram of an example user interface including a contextual menu displayed after a user has released a held touch while the indication is displayed;

FIG. 5D is a diagram of an example user interface including a first object with a changed appearance after a user has moved a held touch over the object;

FIG. 5E is a diagram of an example user interface including a second object with a changed appearance after a user has moved a held touch over the object;

FIG. 5F is a diagram of an example user interface after a user has released the held touch on the second object;

FIG. 5G is a diagram of an example user interface that has scrolled after a user has moved the held touch proximate to an edge of the window; and

FIG. 5H is a diagram of an example user interface after the user has released the held touch in a position without a corresponding object.

### DETAILED DESCRIPTION

As detailed above, touch-sensitive displays allow a user to provide input to a computing device in a more intuitive manner. Despite its many benefits, touch-based input can introduce difficulties depending on the configuration of the touch driver, the operating system, and the applications executing on the device.

For example, in some touch-enabled devices, in order to activate an object such as a hyperlink or button, a user taps his or her finger on the object. Providing this command can raise some difficulties when the object to be selected is small or when the touch-sensitive display is small, as the user's touch may fail to select the intended object. Similarly, if there are a number of selectable objects crowded in the area, the user may accidentally select the wrong object. Although a user can sometimes address this problem by activating a zoom function, this requires additional input from the user, thereby reducing the usability of the device.

To address these issues, example embodiments disclosed herein provide for a touch-based mechanism for selecting or otherwise performing actions on user interface objects. Initially, a computing device including a touch-sensitive display detects a user's touch held at a given position of the touch-sensitive display for a given duration of time. After the touch is held for the given duration of time, the device enters a hover mode in which the device tracks movement of the touch while the touch remains held on the touch-sensitive display. Finally, after the user releases the touch, the device performs an action on a user interface object located at the position of the release of the touch, such as an action corresponding to a single tap of the user interface object.

In this manner, example embodiments disclosed herein allow a user to quickly and accurately select an intended object, thereby increasing usability and decreasing user frustration. Additional embodiments and advantages of such embodiments will be apparent to those of skill in the art upon reading and understanding the following description.

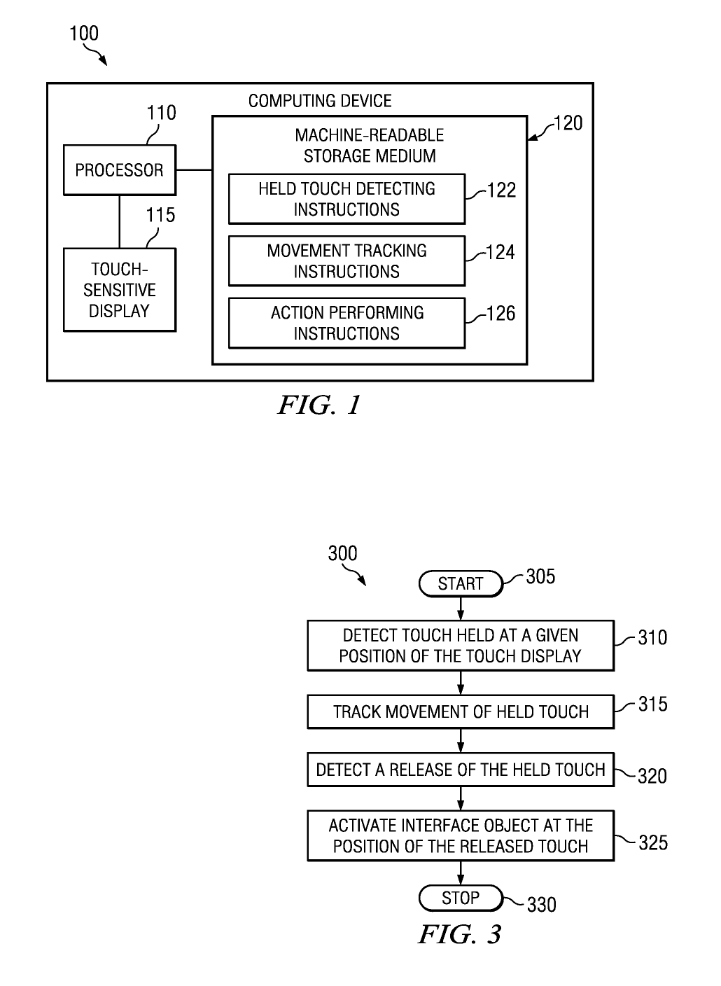

Referring now to the drawings, FIG. 1 is a block diagram of an example computing device 100 for detection of a held touch on a touch-sensitive display 115. Computing device 100 may be, for example, a notebook computer, a desktop computer, an all-in-one system, a tablet computing device, a surface computer, a portable reading device, a wireless email device, a mobile phone, or any other computing device including a touch-sensitive display 115. In the embodiment of FIG. 1, computing device 100 includes processor 110, touch-sensitive display 115, and machine-readable storage medium 120.

Processor 110 may be one or more central processing units (CPUs), semiconductor-based microprocessors, and/or other hardware devices suitable for retrieval and execution of instructions stored in machine-readable storage medium 120. Processor 110 may fetch, decode, and execute instructions 122, 124, 126 to implement the held touch command described in detail below. As an alternative or in addition to retrieving and executing instructions, processor 110 may include one or more integrated circuits (ICs) or other electronic circuits that include electronic components for performing the functionality of one or more of instructions 122, 124, 126.

Touch-sensitive display 115 may be any combination of hardware components capable of outputting a video signal and receiving user input in the form of touch. Thus, touch-sensitive display 115 may include components of a Liquid Crystal Display (LCD), Light Emitting Diode (LED) display, or other display technology for outputting a video signal received from processor 110 or another component of computing device 100. In addition, touch-sensitive display 115 may include components for detecting touch, such as the components of, for example, a resistive, capacitive, surface acoustic wave, infrared, optical imaging, dispersive signal sensing, or in-cell system.

Machine-readable storage medium 120 may be any electronic, magnetic, optical, or other physical storage device that contains or stores executable instructions. Thus, machine-readable storage medium may be, for example, Random Access Memory (RAM), an Electrically Erasable Programmable Read-Only Memory (EEPROM), a storage device, an optical disc, and the like. As described in detail below, machine-readable storage medium 120 may be encoded with a series of executable instructions 122, 124, 126 for detecting and tracking the movement of a touch held on touch-sensitive display 115. Instructions 122, 124, 126 may be implemented by an operating system (OS) of computing device 100, by an application executing within the OS, or by a combination of the two, depending on the particular implementation.

Machine-readable storage medium 120 may include held touch detecting instructions 122, which may detect a touch held at a given position of touch-sensitive display 115 for a given duration of time. For example, upon detection of a touch at a given set of coordinates, touch-sensitive display 115 may convey a touch event indicating the coordinates to detecting instructions 122. Instructions 122 may then detect subsequent events received from touch-sensitive display 115 to determine whether the touch is held at substantially the same coordinates for a given period of time. This period of time may be, for example, 1 second, 1.5 seconds, 2 seconds, or any other duration of time suitable for the particular implementation.

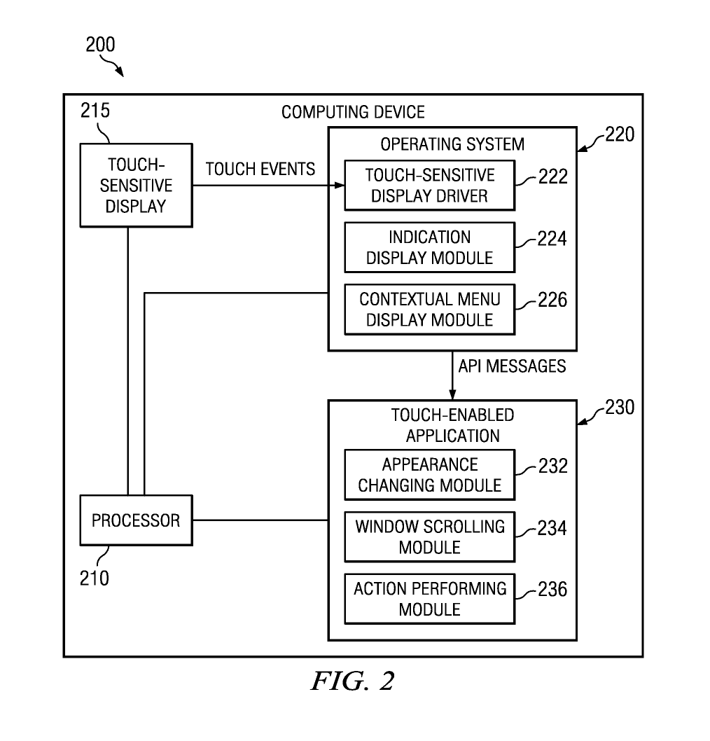

When touch detecting instructions 122 determine that the user has held the touch at substantially the same position for the given period of time, detecting instructions 122 may trigger movement tracking instructions 124. Tracking instructions 124 may implement a hover mode, in which a user may move his or her finger or stylus around touch-sensitive display 115 while keeping the touch depressed on touch-sensitive display 115. During hover mode, computing device 100 may respond similarly to the movement of a mouse without a button depressed in a mouse-based user interface. Thus, in some embodiments, as described further below in connection with FIG. 2, instructions 124 may highlight links or buttons at the location of the held touch as the user moves the touch, thereby providing visible feedback regarding the location of the user's held touch. In addition, in some embodiments, as also described below in connection with FIG. 2, instructions 124 allow the user to scroll the viewable area of the graphical user interface (GUI) when the user moves the held touch close to the border of the current window.

While the touch remains held, movement tracking instructions 124 may continue to monitor touch events received from touch-sensitive display 115 for detection of a touch release event. Upon receipt of such an event, movement tracking instructions 124 may trigger action performing instructions 126. If the user's touch is not currently over a selectable user interface object when the touch is released, action performing instructions 126 may then exit hover mode, such that computing device 100 resumes normal detection of user touches.

Alternatively, when the user's touch at the time of the release is currently over a selectable user interface object, such as a hyperlink or button, action performing instructions 126 may perform an action on the user interface object that corresponds to a selection of the user interface object. For example, the performed action may correspond to the action taken in response to a single tap of the user interface object during typical touch operation (i.e., non-hover mode). Stated differently, the performed action may correspond to the action taken in response to a single or double left click in a mouse-based interface. For example, action performing instructions 126 may follow a hyperlink, thereby triggering loading of a new page in a current application. Similarly, action performing instructions may activate a button, such as a checkbox, menu item, or standalone button, thereby opening an application or document, taking an action in the current application, etc.

FIG. 2 is a block diagram of an example computing device 200 including an operating system 220 and an application 230 that interact to detect and respond to a held touch on a touch-sensitive display 215. As with processor 110, processor 210 may be a CPU or microprocessor suitable for retrieval and execution of instructions and/or one or more electronic circuits configured to perform the functionality of one or more of the modules described below. Similarly, as with touch-sensitive display 115, touch-sensitive display 215 may be any combination of hardware components capable of outputting a video signal and receiving user input in the form of touch.

Operating system (OS) 220 may be implemented as a series of executable instructions for managing the hardware of computing device 200 and for providing an interface for applications, such as touch-enabled application 230, to access the hardware. Each of the modules 222, 224, 226 included in OS 220 may be implemented as a series of instructions encoded on a machine-readable storage medium of computing device 200 and executable by processor 210. In addition or as an alternative, the modules 222, 224, 226 may be implemented as hardware devices including electronic circuitry for implementing the functionality described below. It should be noted that, in some embodiments, one or more of modules 222, 224, 226 may instead be implemented by touch-enabled application 230, described in detail below.

Touch-sensitive display driver 222 may include a series of instructions for receiving touch events from touch-sensitive display 215, interpreting the events, and forwarding appropriate notifications to OS 220. In particular, touch-sensitive display driver 222 may implement instructions for detecting a touch held on display 215, tracking movement of the touch while the touch is held on display 215, and detecting a release of the touch from display 215.

For example, driver 222 may receive an interrupt signal from touch-sensitive display 215 each time a user touches the display 215 and may continue to periodically receive such a signal while the touch remains held on display 215. Driver 222 may interpret the signal received from display 215 and communicate details of the touch to operating system 220. In response, OS 220 may generate Application Programming Interface (API) messages and may forward these messages to touch-enabled application 230.

To give a specific example, in a Windows® environment, touch-sensitive display driver 222 may be configured to communicate with the Windows kernel. Thus, upon receipt of an interrupt from touch-sensitive display 215, driver 222 may interpret the received signal and provide details of the received input to the kernel of the Windows OS 220. In response, OS 220 may generate Windows API messages for transmission to touch-enabled application. For example, OS 220 may generate a WM_TOUCH message containing a specified number of touch points and a corresponding number of handles that may be used to access detailed information about each touch point. Application 230 may then parse the WM_TOUCH message to obtain details about the touch input and respond accordingly.

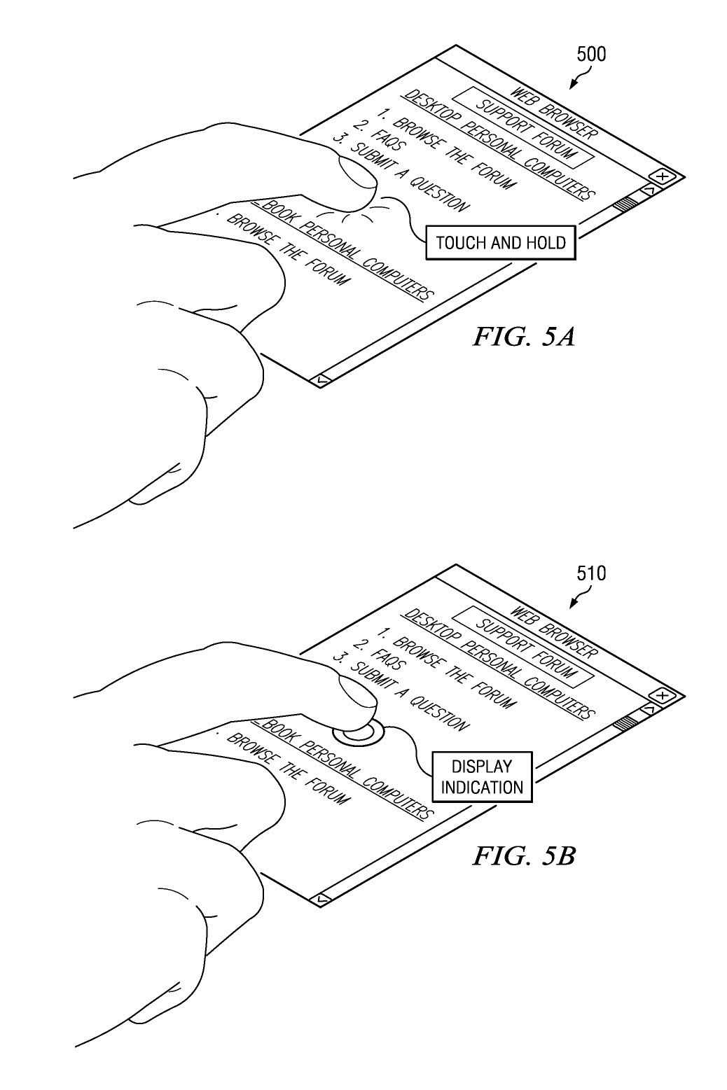

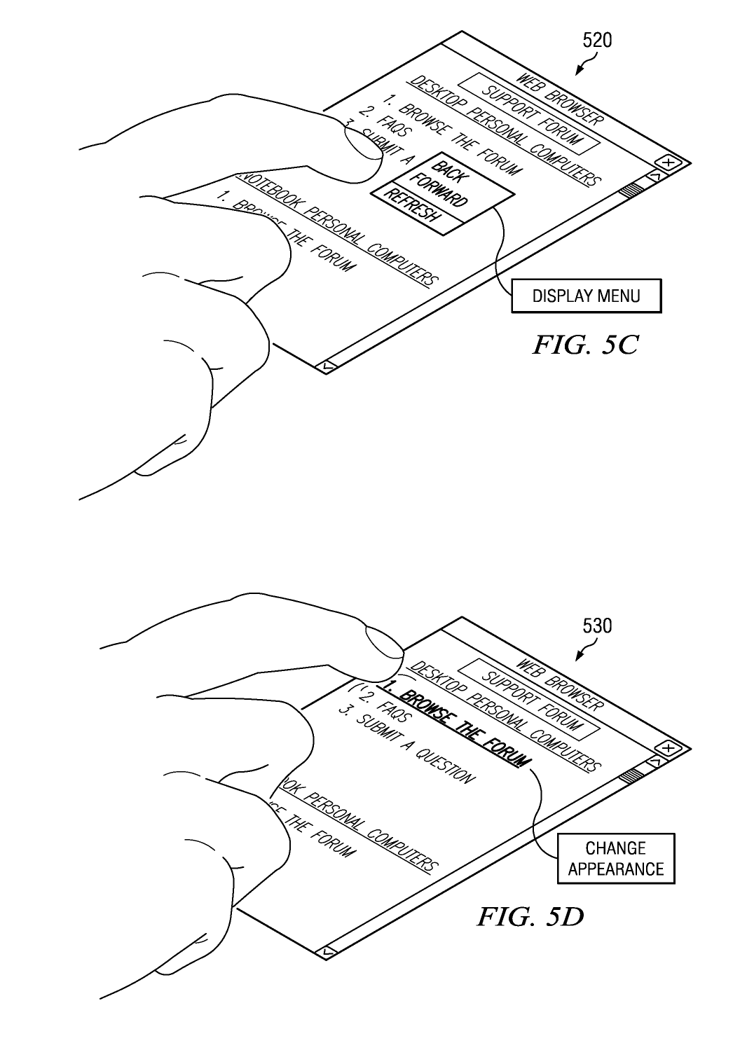

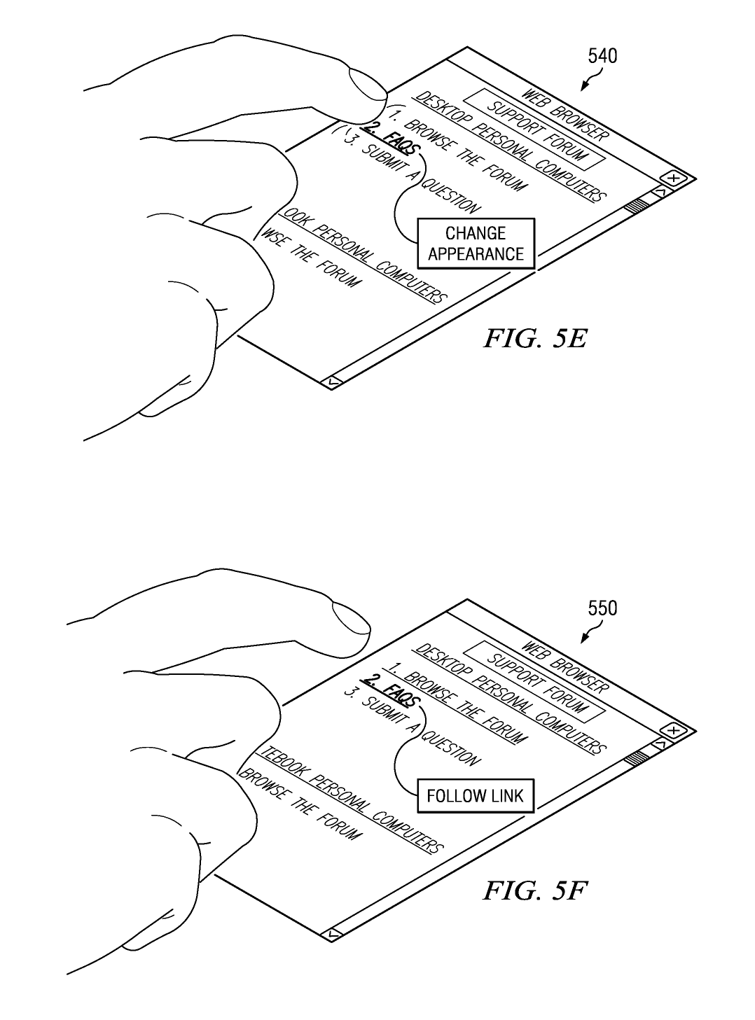

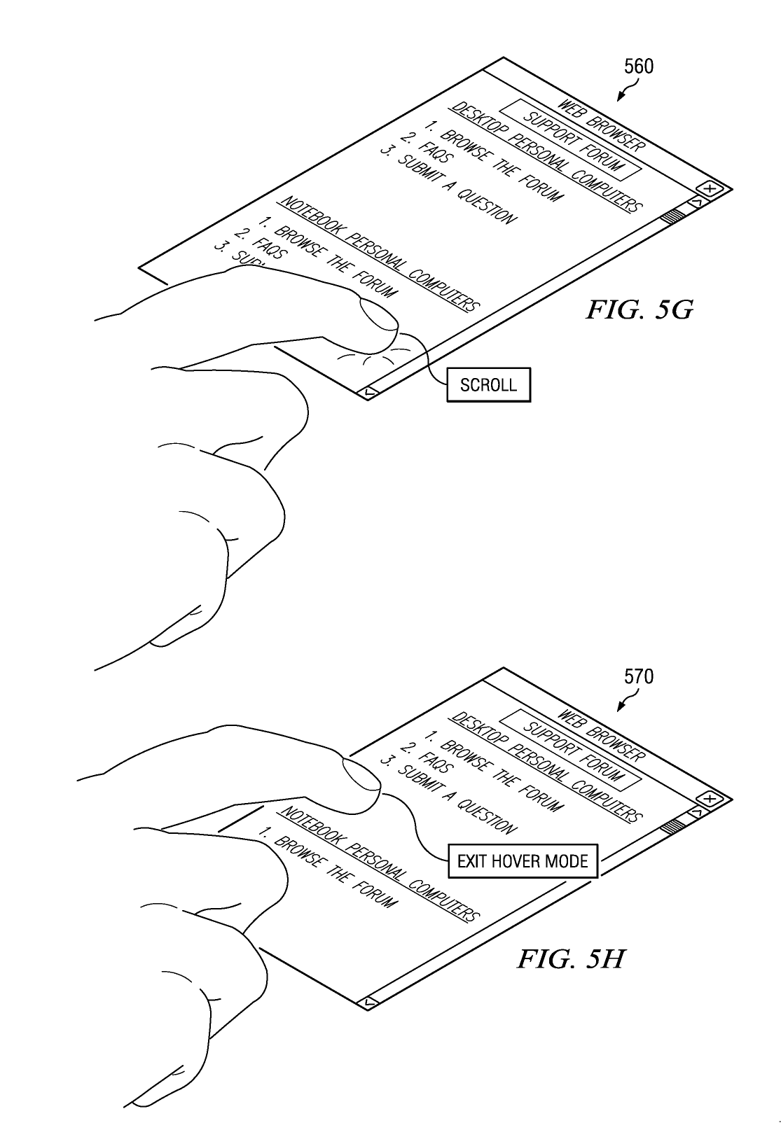

Indication display module 224 may output an indication proximate to the touch upon detection of a touch held for a given duration of time. For example, upon detecting the held touch, indication display module 224 may output a shape, icon, or other visible indication at the location of the touch, thereby notifying the user that he or she has held the touch for a given period of time. As a specific example, the indication may be a circle surrounding the touched location, as described below in connection with FIG. 5B.

Contextual menu display module 226 may output a menu containing a number of items when the held touch is released while the indication is displayed. For example, after display of the indication by module 224, computing device 200 may begin counting a predetermined period of time, When the touch is released within the predetermined period of time, menu display module 226 may output the menu. The menu may include, for example, a number of actions that may be performed based on the current location of the touch. The included actions may be actions typically available in a right-click menu, such as copy, cut, or paste, refresh, dose, minimize, back, and the like. Alternatively, assuming that the touch is not released within the predetermined period of time, computing device 200 may enter hover mode, as described above.

As with OS 220, touch-enabled application 230 may be implemented as a series of executable instructions and may interact with OS 220 to provide touch functionality to a user. Each of the modules 232, 234, 236 included in application 230 may be implemented as a series of instructions encoded on a machine-readable storage medium of computing device 200 and executable by processor 210. In addition or as an alternative, the modules 232, 234, 236 may be implemented as hardware devices including electronic circuitry for implementing the functionality described below. It should be noted that, in some embodiments, one or more of modules 232, 234, 236 may instead be implemented by OS 220, described in detail above.

Appearance changing module 232 may change the appearance of user interface objects as the held touch is moved about display 215. For example, changing module 232 may receive an API message from OS 220 and, based on that message, determine whether a UI object capable of being activated is located at the position of the held touch. If so, appearance changing module 232 may modify the appearance of the UI object, thereby providing the user with feedback that he or she is currently hovering over the particular object.

To give a few examples, appearance changing module 232 may modify the font, size, and/or color of the particular object. For example, when the UI object is a hyperlink, module 232 may change the font of the link to a bold typeface or change the color of the font. As another example, when the UI object is a button, module 232 may add an outline around the button, change the font used for the label, etc. Other suitable appearance changes will be apparent based on the type of UI object.

Window scrolling module 234 may scroll a viewable area of the current window of touch-enabled application 230 when the held touch moves proximate to an edge of the window. For example, window scrolling module 234 may monitor the coordinates of the touch provided in the API messages to determine when the touch is within a predetermined number of pixels from the edge. When this condition is satisfied, window scrolling module 234 may then scroll the window in a direction corresponding to the location of the held touch (e.g., scroll up when the touch is near the top of the window, scroll down when the touch is near the bottom, etc.). In addition, the rate at which the window scrolls may vary based on the proximity of the touch to the edge of the current window. For example, as the touch moves closer to the edge, the scrolling speed may increase. In this manner, the user may scroll the viewable area of the current window to select a UI object not currently in view while remaining in hover mode.

Upon receipt of an API message indicating that the held touch was released, action performing module 236 may activate a user interface object located at a position of the release of the touch. For example, as detailed above in connection with action performing instructions 126, action performing module 236 may perform the same action taken in response to a single tap of the user interface object during normal touch operation (i.e., in non-hover mode). The user may thereby move the touch while the touch remains held and, upon release of the touch, activate the intended user interface object with a high level of accuracy.

FIG. 3 is a flowchart of an example method 300 for detection of a held touch on a touch-sensitive display. Although execution of method 300 is described below with reference to computing device 100, other suitable components for execution of method 300 will be apparent to those of skill in the art (e.g., computing device 200). Method 300 may be implemented in the form of executable instructions stored on a machine-readable storage medium, such as storage medium 120, and/or in the form of electronic circuitry.

Method 300 may start in block 305 and continue to block 310, where computing device 100 may detect a touch held for a predetermined duration of time at a given position of a graphical user interface outputted on touch-sensitive display 115. After detection of the held touch, method 300 may then continue to block 315, where computing device 100 may track the movement of the touch on touch-sensitive display 115 while the touch remains held.

Next, in block 320, computing device 100 may detect a release of the touch from touch-sensitive display 115. Finally, in block 325, in response to the release of the touch, computing device 100 may take an action on the user interface object located in the GUI at a position of the release of the touch. In some embodiments, this action may be the same action taken when the user taps the object once during normal touch operation (e.g., a select action in non-hover mode). After performing the appropriate action on the user interface object, method 300 may proceed to block 330, where method 300 may stop.

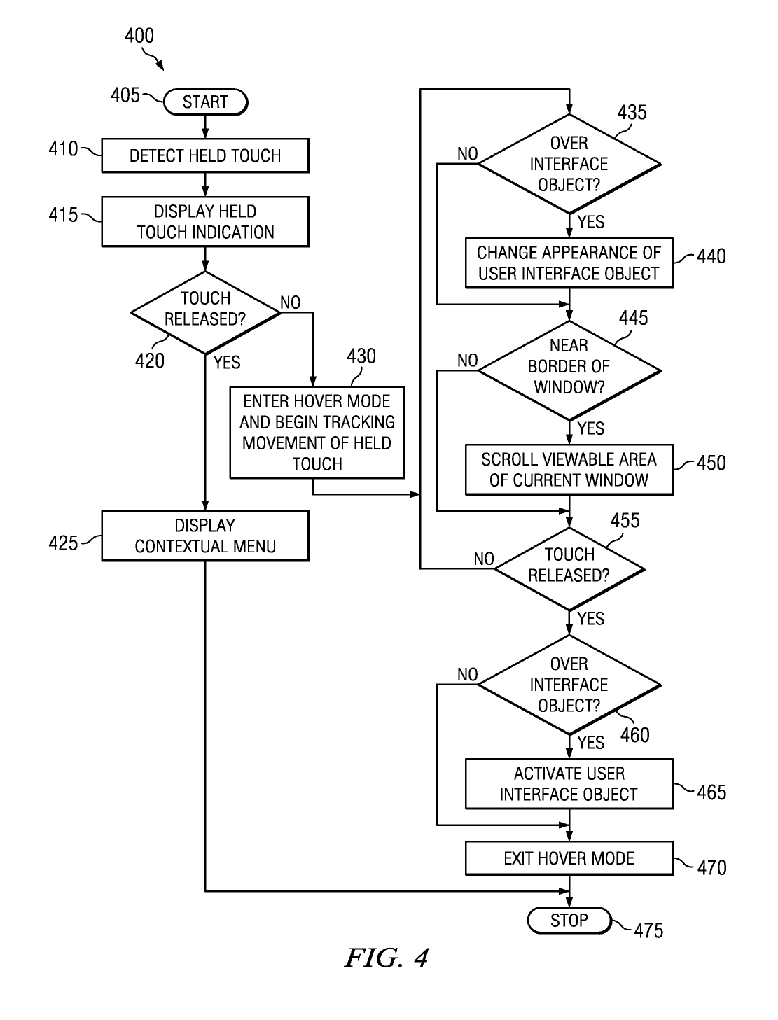

FIG. 4 is a flowchart of an example method 400 for detection of a held touch, the method changing the appearance of user interface objects and scrolling a viewable area of a current window. Although execution of method 400 is described below with reference to computing device 200, other suitable components for execution of method 400 will be apparent to those of skill in the art. Method 400 may be implemented in the form of executable instructions stored on a machine-readable storage medium and/or in the form of electronic circuitry.

Method 400 may start in block 405 and proceed to block 410, where computing device 200 may detect a touch held on touch-sensitive display 215. For example, as shown in FIG. 5A, the user may hold his or her finger on display 215 and, in response, computing device 200 may begin timing the duration of the held touch.

In block 415, after the user has held the touch for a given duration of time, computing device 200 may output an indication indicating that the user has held the touch for the given duration of time. This indication may be any shape, icon, image, text, or any combination thereof. For example, as shown in FIG. 5B, computing device 200 may output a circle surrounding the area of the touch.

In block 420, computing device 200 may continue monitoring the touch to determine whether the touch is released within a predetermined period of time subsequent to the display of the indication. If so, method 400 may proceed to block 425, where computing device 200 may display a contextual menu, such as the menu illustrated in FIG. 5C. Method 400 may then continue to block 475, where method 400 may stop. Otherwise, if the touch is held for the predetermined period of time after display of the indication, computing device 200 may remove the indication and method 400 may proceed to block 430.

In block 430, computing device 200 may enter hover mode and computing device 200 may therefore begin tracking movement of the held touch. In block 435, computing device 200 may determine whether the held touch is located over a user interface object capable of being activated, such as a link, a button, a menu item, or other interface object, If so, method 400 may continue to block 440, where computing device 200 may change the appearance of the object by, for example, changing the font, size, color, border, or other graphical feature of the object, as illustrated in FIGS. 5D and 5E. Method 400 may then continue to block 445. Alternatively, if it is determined that the held touch is not located over a user interface object, method 400 may skip directly to block 445.

In block 445, computing device 200 may determine whether the held touch is located near the border of the current window of the GUI. If so, method 400 may continue to block 450, where computing device 200 may scroll the viewable area of the GUI in a direction corresponding to the location of the touch, as illustrated in FIG. 5G. Method 400 may then continue to block 455. Alternatively, if it is determined that the held touch is not located near the border of the current window, method 400 may skip directly to block 455.

In block 455, computing device 200 may determine whether the held touch has been released. If the user has continued to hold the touch, method 400 may return to block 435. Otherwise, if the user has released the touch, method 400 may continue to block 460.

In block 460, computing device 200 may determine whether the location of the released touch corresponds to the position of a user interface object capable of being activated. If so, method 400 may continue to block 465, where computing device 200 may activate the user interface object. For example, as illustrated in FIG. 5F, computing device 200 may follow a hyperlink located at the position of the released touch. Method 400 may then continue to block 470. Alternatively, if it is determined that the released touch is not at the position of a user interface element, method 400 may skip directly to block 470.

Finally, in block 470, computing device 200 may exit hover mode, as illustrated in FIG. 5H. Subsequent to exiting hover mode, computing device 200 may process touch input in a conventional manner and may repeat execution of method 400 upon receipt of a next held touch. Method 400 may then continue to block 475, where method 400 may stop.

FIG. 5A is a diagram 500 of an example user interface in which a user has initiated a held touch. As illustrated, the user has depressed his or her index finger on the touch-sensitive display and has held the finger on the display. In response, computing device 100, 200 begins timing the duration of the held touch.

FIG. 5B is a diagram 510 of an example user interface including an indication displayed after a user has held a touch for a given duration of time. As illustrated, after holding the touch in the given location for a predetermined period of time, computing device 100, 200 outputs a circle surrounding the touched area. The displayed circle thereby notifies the user that he or she may enter hover mode by continuing to hold the touch.

FIG. 5C is a diagram 520 of an example user interface including a contextual menu displayed after a user has released a held touch while the indication is displayed. As illustrated, when the user releases the held touch within a predetermined period of time from display of the indication, computing device 100, 200 outputs a contextual menu containing back, forward, and refresh commands. The user may then tap any of the displayed commands to activate the corresponding function.

FIG. 5D is a diagram 530 of an example user interface including a first object with a changed appearance after a user has moved a held touch over the object. Similarly, FIG. 5E is a diagram 540 of an example user interface including a second object with a changed appearance after a user has moved a held touch over the object. As illustrated in these figures, during hover mode, when the user moves the held touch over a hyperlink, computing device 100, 200 modifies the font of the displayed link to be boldface and underlined.

FIG. 5F is a diagram 550 of an example user interface after a user has released the held touch on the second object. As illustrated, the user has released the held touch while the touch was over the link “FAQs.” Accordingly, computing device 100, 200 may load the webpage at the address identified by the hyperlink.

FIG. 5G is a diagram 560 of an example user interface that has scrolled after a user has moved the held touch proximate to an edge of the window. As illustrated, during hover mode, the user has continued to hold the touch and has moved the touch adjacent to the bottom of the displayed window. Computing device 100, 200 has therefore scrolled the viewable area of the current window in the downward direction.

FIG. 5H is a diagram 570 of an example user interface after the user has released the held touch in a position without a corresponding object. As illustrated, the user has released the held touch and, at the time of the release, the held touch was not over a particular user interface object. Accordingly, computing device 100, 200 has exited hover mode.

According to the foregoing, example embodiments disclosed herein provide a simple, intuitive mechanism for selecting a user interface object outputted on a touch-sensitive display. In particular, example embodiments enable a user to quickly and accurately perform an action of a user interface object using a simple touch command.

We claim:

1. A computing device for detection of touches, the computing device comprising:
a touch-sensitive display; and
a processor to:
detect a touch held at a given position of the touch-sensitive display for a duration of time,
track movement of the touch while the touch remains held on the touch-sensitive display, and
activate a user interface object located at a position of a release of the held touch.

2. The computing device of claim 1, wherein the processor is further configured to:
display an indication proximate to the touch upon detection of the touch held for the duration of time, and
display a contextual menu in response to a release of the touch within a predetermined duration of time subsequent to display of the indication.

3. The computing device of claim 1, wherein the processor is further configured to:
change, during tracking movement of the touch, an appearance of each respective user interface object capable of being activated while the touch is at a position of the respective user interface object.

4. The computing device of claim 3, wherein, to change the appearance of the respective user interface object, the processor is configured to modify at least one of a size, a font, and a color of the respective user interface object.

5. The computing device of claim 1, wherein the processor is further configured to:
scroll a viewable area of a graphical user interface (GUI) outputted on the touch-sensitive display when the held touch moves proximate to an edge of a current window in the GUI.

6. The computing device of claim 1, wherein, to activate the user interface object, the processor performs an action performed in response to a single tap of the user interface object during normal touch operation.

7. A machine-readable storage medium encoded with instructions executable by a processor of a computing device including a touch-sensitive display, the machine-readable storage medium comprising:
instructions for detecting a touch held at a given position of the touch-sensitive display;
instructions for tracking movement of the touch while the touch is held on the touch-sensitive display;
instructions for detecting a release of the touch from the touch-sensitive display; and
instructions for activating a user interface object located at a position of the release of the touch.

8. The machine-readable storage medium of claim 7, wherein:
the instructions for detecting the touch held, the instructions for tracking the movement, and the instructions for detecting the release are implemented by a driver of the operating system (OS) of the computing device, and
the instructions for activating are implemented by an application executing within the OS.

9. The machine-readable storage medium of claim 7, further comprising:
instructions for changing an appearance of each respective user interface object capable of being activated while the held touch is at a position of the respective user interface object.

10. The machine-readable storage medium of claim 7, further comprising:
instructions for scrolling a viewable area of a graphical user interface (GUI) outputted on the touch-sensitive display when the held touch moves proximate to an edge of a current window in the GUI.

11. A method for detection of touches on a touch-sensitive display, the method comprising:
detecting a touch held for a predetermined duration of time at a given position of a graphical user interface (GUI) outputted on the touch-sensitive display;
tracking movement of the touch on the touch-sensitive display while the touch remains held;
detecting a release of the touch from the touch-sensitive display; and
taking an action on a user interface object located in the GUI at a position of the release of the touch, the action corresponding to an action taken in response to a single tap of the user interface object.

12. The method of claim 11, further comprising:
displaying an indication proximate to the touch upon detection of the touch held for the predetermined duration of time.

13. The method of claim 12, further comprising:
displaying a contextual menu in response to a release of the touch within a second predetermined duration of time subsequent to displaying the indication, and
removing the indication when the touch remains held during the second predetermined duration of time.

14. The method of claim 11, further comprising:
during tracking the movement of the touch, changing an appearance of each respective user interface object capable of being activated while the held touch is at a position of the respective user interface object.

15. The method of claim 11, further comprising:
scrolling a viewable area of the GUI in a direction corresponding to a location of the touch when the touch moves proximate to an edge of a current window in the GUI.
